(19) United States
(12) Patent Application Publication
(10) Pub. No.: US 2004/0202696 A1
(43) Pub. Date: Oct. 14, 2004

(54) Administration form for veterinary use

(75) Inventors: Rina Yamin, Rehovot (IL); Sigal First, Ramat HaSharon (IL); Alona Rom, Mazkeret Batiya (IL)

Correspondence Address: OLIFF & BERRIDGE, PLC, P.O. BOX 19928, ALEXANDRIA, VA, 22320, US

(73) Assignee: CTS CHEMICAL INDUSTRIES LTD., Kiryat Malachi (IL)

(21) Appl. No.: 10/412,260

(22) Filed: Apr. 14, 2003

(51) Int. Cl. A23K 1/165

(52) U.S. Cl. 424/442

(57) ABSTRACT

The present invention provides an oral administration form for animals, especially pets, comprising an oily liquid and at least one solid, oil-insoluble active ingredient dispersed in said oily liquid. The suspension is of a kind that n may be homogenized by shaking, and that may be easily poured out of a bottle. The oral administration form of the invention is preferably palatable to animals, it exhibits outstanding stability with water-sensitive active ingredients, and is readily accepted by animals that has to take it.

### FIELD OF THE INVENTION

The invention relates to administration forms for veterinary use.

### BACKGROUND OF THE INVENTION

When giving medicines to animals, and in particular to pets, such as dogs and cats, administration forms that were designed for the intake by people are usually used. Thus, animals are required to swallow tablets, and very frequently they try in all their force not to swallow them. Preparations other than tablets, such as syrups, are also extremely non-palatable to pets, and it is many times practically impossible to make them take such a preparation. Therefore, there is a need in the art to provide novel oral administration forms for veterinary use.

WO9802143 describes an orally administrable, pastelike composition for veterinary use, in particular for ruminants, and more particularly a composition comprising a calcium compound for controlling milk fever. A veterinarily active compound is suspended in a two phase oily composition comprising a liquid, veterinarily acceptable oil component and a solid, veterinarily acceptable fat component, said fat component forming a coherent structure of crystals in said liquid oil component

RU2180559 describes an injection preparation for treating mastitis in animals. The preparation contains, g/ml injection dose: gentamycin sulfite 0.017, dioxidine 0.01, soft monoglyceride 0.03, solid monoglyceride 0.03, oil-up to 1.0. The preparation is prepared by dispersing an antibiotic powder in an oily base (oil and emulsifiers) in a colloid grinder to obtain homogeneous and stable suspension.

### SUMMARY OF THE INVENTION

According to a first aspect of the present invention, there is provided an oral administration form for veterinary use, comprising at least one solid substance which include an oil-insoluble active ingredient, said at least one solid substance being dispersed in an oily liquid.

The term oral is used herein to teach that the administration form of the invention has to be swallowed.

The administration form of the invention is suitable for use by animals in general, and especially by pets. Pets include all domesticated animals kept for pleasure rather than utility, in particular mammals, such as dogs and cats.

The active ingredient according to the invention is preferably solid at room temperature, and has a melting point of above 35° C., so it is taken by the animal in its solid state.

The active ingredient may be dispersed directly in the oily liquid, or it may be absorbed on the surface of powder particles, and these particles are dispersed in the oily liquid. This last possibility is particularly advantageous when the active ingredient is to be given in a low dose, such that by shaking a dispersion of the active ingredient in the oily liquid, it is not practical to expect the formation of a homogeneous suspension. Absorbing the active ingredient on powder particles, and then dispersing these particles in the liquid, allows for the formation of a homogeneous suspension of a low-dose active ingredient.

An administration form according to the invention may include any number (n₁) of active ingredients directly dispersed in an oily liquid; any number (n₂) of low-dose active ingredients absorbed on powder particles that are dispersed in the oily liquid; and any number (n₃) of oil-soluble active ingredients, provided that the sum of n₁ and n₂ is at least 1. The term administration form should be construed in a broad sense and include any form administered for the purpose of achieving a therapeutic or nutritional effect in animals. It may be sold as a pharmaceutical administration form carrying a label as to the intended indication, whether as a prescription drug or over the counter, or it may be sold without any specific indication, for example as a neutraceutical (neutraceuticals are often referred to as “food additives” or “food supplements”), herbal extract, homeopathic extract, etc. Examples to active ingredients are antibiotics, worm remover, bronchodilating agents, anti-diarrhea agents, antihistamines, anti-rheumatics, hormones, analgesics, diuretics, radiophamaceutics, plant extracts, homeopathic medicines, vitamins, minerals, etc.

A substance is said to be oil insoluble if its solubility in oil is less than 1 to 100 such that mixing 1 gram of substance in 100 grams of oil will not produce a clear solution.

In the context of the present invention, a semi-liquid may also be considered as a liquid. The main requirement from a substance to be named liquid in the context of the present invention is its ability to flow, such that it may be easily poured out of a bottle, and may be efficiently mixed upon being shaken, for instance by a animal-keeper, that shakes a bottle half fill of an administration form according to the invention before administering it to the An oily liquid is a liquid made substantially of oils, possibly together with thickening agents such as waxes, hydrogenated oils, fatty alcohols, fatty esters, polyethylene glycol and other thickening substances.

A suspension should be understood in the context of the present invention as a heterogeneous mixture of solid particles in a liquid medium, which may be brought to a state characterized by a homogenous concentration of the solid particles upon vigor shaking by a person, preferably for about 30 seconds or less.

An administration form according to the invention may comprise further non-active ingredients such as, thickening agents, carriers for low-dose medicines, flavors, sweeteners, colors, antioxidants, etc. An administration form according to the invention has the advantage of being palatable to the animals, to which it is administered. In case the active ingredient dissolves or disintegrates in water and has a bad taste, the present invention suggests firer advantage, since the inherent taste of the active ingredient is sensed in a dispersion in a much weaker degree than in solution, one advantage of the present invention over prior art emulsions is that the administration form of the present invention is free from surfactants, and these are frequently associated with bad taste.

Further advantage of the present invention is achieved in case the active ingredient is water sensitive. In such cases it has longer stability in comparison to aqueous administration forms. The ability to pour the administration form of the present invention provides flexibility of dosage used without sacrificing accuracy of dosing.

One advisable manner to administrate an administration form according to the invention is to let the animal drink it, and another, preferable manner, is to mix it with the animal's food. The preparation may also be administered directly to the animal's mouth, for instance by a tea-spoon, a syringe, a dropper, etc. Thus, it allows the administration thereof to an animal in a manner much more efficient than administering to animals administration forms that are designed for humans.

According to another aspect of the present invention there is provided a method of treating a non-human subject, the method comprising orally administering to said subject an administration form according to the invention.

According to another aspect of the present invention there is provided the use of an administration form according to the invention as an oral administration form for non-human subjects.

### DETAILED DESCRIPTION OF SPECIFIC EMBODIMENTS

In order to see how the invention may be carried out in practice, a detailed description of some specific embodiments is given below by way of non-limiting examples only.

In the following examples, all the administration forms are to be swallowed by animals in need thereof after being well shaken. They may be swallowed as such, or when mixed with the animal's food. As well known in the art, larger animals may take in a single administration form larger amounts of medications, including larger amounts of active ingredients.

### EXAMPLE 1

### Multivitamin Supplement

The following ingredients are used for preparing a multivitamin supplement. Amounts are given for a single dose of an administration form of about 5 g.

Vitamin A 500 IU

Vitamin D3 50 IU

Vitamin E 1 IU

Vitamin C 5 mg

Niacinamide 6.5 mg

Thiamine 0.5 mg

Calcium Carbonate 0.4 g

Soybean Oil 4.8 g

White Beeswax 0.2 g

Soybean Oil is thickened by mixing with White Beeswax at 70° C. The obtained oily liquid is cooled to 50° C. and oily vitamins (A, D and E) are added. The oily solution is cooled to 35° C. Powdered water soluble vitamins and calcium carbonate are added and mixed together. The obtained suspension is cooled to room temperature to obtain a pourable suspension of solid vitamins and minerals in a liquid medium. In this example, calcium carbonate functions both as an active ingredient, to supply the pet with calcium, and as a carrier for the low dose oil-insoluble vitamins.

### EXAMPLE 2

### Antibiotic Medicine

The following ingredients are used for preparing an antibiotic medication for pets. Amounts are given for a single dose of an administration form of about 5 g.

Amoxycillin 0.5 g

Peanut Oil 4.2 g

Castor Oil 0.3 g

Butylated Hydroxy Tuluene (BHT) 0.01 g

Oils are heated to 50° C. BHT is added. The obtained oily mixture is cooled to 30° C. under mixing. Amoxycillin powder is added during mixing and further cooling to room temperature.

### EXAMPLE 3

### Hip & Joint Care

The following ingredients are used for preparing a hip and joint care medication. Amounts are given for a single dose of an administration form of about 5 g.

Glucosamine Sulphate 0.25 g

Castor Oil 4.3 g

Hydrogenated Palm Oil 0.3 g

Beef Flavor 0.1 g

Oils are heated to 50° C. and glucosamine is added thereto with mixing.

The obtained suspension is cooled to 30° C. and flavor is added.

### EXAMPLE 4

### Anti-diarrhea Medication

The following ingredients are used for preparing ant-diarrhea medication. Amounts are given for a single dose of an administration form of

about 5 g.

Kaolin Light 0.3 g

Corn Oil 4.3 g

Cethyl Alcohol 0.1 g

Glyceryl Monostearate 01 g

Propyl Gallate 0.01 g

Corn Oil, Glyceryl Monostearate, Propyl Gallate and Cethyl Alcohol are heated to 75° C. and mixed together. Kaolin is added. The suspension is cooled while homogenization is applied.

### EXAMPLE 5

### Worm Remover

The following ingredients are used for preparing a worm remover. Amounts are given for a stock of about 5 kg, which suffice for about 1000 single doses.

Pyrantel Pamoate 0.15 Kg

Mineral Oil 4.8 Kg

Mineral Oil is heated to 50° C. and Pyrantel Pamoate added and mixed and homogenized. The obtained preparation is cooled and filled into bottles.

### EXAMPLE 6

### Bronchodilating Medication

The following ingredients are used for preparing a broncholidating medication. Amounts are given for a batch of about 500 g, which suffices to about 100 single doses.

Clenbuterol 20 mg

Microcrystalline Cellulose 50 g

PEG 6000 50 g

Soybean Oil 450 g

Clenbuterol is absorbed on microcrystalline cellulose to form an homogeneous powder.

Soybean oil is thickened by mixing with PEG 6000 while heating to 50° C. The above mentioned powder is suspended inside the hot mixture, which is then cooled to room temperature to obtain a batch of about 100 doses of an administration form, according to the invention.

### EXAMPLE 7

### Plant Extract Remedy

The following ingredients are used for preparing a plant extract care medication. Amounts are given for a single dose of an administration form of about 5 g.

Echinacea Dry Extract 0.1 g

Chamomile Dry Extract 0.1 g

Fennel Dry Extract 0.1 g

Soybean Oil 4.4 g

Hydrogenated Vegetable Oil 0.3 g

Oils are heated to 50° C. and herbal extracts are added thereto with mixing. The obtained suspension is cooled to 30° C.

1. An oral administration form for veterinary use, comprising at least one solid substance which include an oil-insoluble active ingredient, said at least one solid substance being dispersed in an oily liquid.

2. An oral administration form according to claim 1, wherein each of said at least one solid substances is selected from the group consisting of an oil-insoluble active ingredient and an oil-insoluble powder absorbed with an oil insoluble active ingredient.

3. An oral administration from according to claim 2, wherein said powder is absorbed with a low-dose active ingredient.

4. An oral administration form according to claim 1 further comprising an oil-soluble active ingredient.

5. An oral administration form according to claim 1, adopted for use by pets.

6. An oral administration form according to claim 5, wherein said pets are cats or dogs.

7. An oral administration form according to claim 1, wherein said active ingredient is selected from the group consisting of antibiotics, worm removers, bronchodilating agents, anti-diarrhea agents, antihistamines, anti-rheumatics, hormones, analgesics, diuretics, radiopharmaceutics, vitamins, and minerals.

8. An oral administration form according to claim 1, wherein said oily liquid comprises at least one oil.

9. An oral administration form according to claim 8, wherein said oily liquid further comprising at least one thickening agent.

10. An oral administration form according to claim 9, wherein said thickening agents are selected from the group consisting of waxes, hydrogenated oils, fatty alcohols, fatty esters, polyethylene glycol and other thickening substances.

11. An oral administration form according to claim 1, that is palatable to animals.

12. An oral administration form according to claim 1, further comprising at least one non-active ingredient selected form the group consisting of thickening agents, flavors, sweeteners, colors, plant extracts, and antioxidants.

13. An oral administration form according to claim 1, wherein said active ingredient is water sensitive.

14. An oral administration form according to claim 1, wherein said active ingredient dissolves or disintegrates in water.

15. An oral administration form according to claim 1, which is free from surfactants.

16. A method of treating a non-human subject comprising orally administering to said subject an administration form which comprises at least one solid substance including an oil-insoluble active ingredient, said at least one solid substance being dispersed in an oily liquid.

17. A method according to claim 16, wherein each of said at least one solid substance is selected from the group consisting of an oil-insoluble active ingredient and an oil-insoluble powder absorbed with an oil insoluble active ingredient.

18. A method according to claim 17 wherein said powder is absorbed with a low-dose active ingredient.

19. A method according to claim 16, wherein said non-human subject is a pet.

20. A method according to claim 19, wherein said pet is a dog or a cat.

21. A method according to claim 16, wherein said active ingredient is anti-diarrhea agents, antihistamines, anti-rheumatics, hormones, analgesics, diuretics, radiopharmaceutics, vitamins, and minerals.

22. A method according to claim 16, wherein said oily liquid comprises at least one oil.

23. A method according to claim 22, wherein said oily liquid further comprising at least one thickening agent.

24. A method according to claim 23, wherein said thickening agent is selected from the group consisting of waxes, hydrogenated oils, fatty alcohols, fatty esters, and polyethylene glycol.

25. A method according to claim 16, wherein said administration form is palatable to animals.

26. A method according to claim 16, wherein said administration form further comprising at least one oil-soluble active ingredient.

27. A method according to claim 16, wherein said administration form further comprising at least one non-active ingredient selected from the group consisting of thickening agents, flavors, sweeteners, colors, plant extracts, and antioxidants.

28. A method according to claim 16, wherein said active ingredient is water sensitive.

29. A method according to claim 16, wherein said active ingredient dissolves or disintegrates in water.

30. A method according to claim 16, wherein said administration form is free from surfactants.

31. A method according to claim 16 wherein said administration form is given to the animal with its food.

32. A use of a at least one solid oil-insoluble substance that includes an active ingredient and is dispersed in an oily liquid, as an oral administration form for non-human subjects.

33. A use according to claim 32, wherein said oral administration form is for veterinary use, comprising at least one solid substance which include an oil-insoluble active ingredient, said at least one solid substance being dispersed in an oily liquid, wherein each of said at least one solid substances is selected from the group consisting of an oil-insoluble active ingredient and an oil-insoluble powder absorbed with an oil-insoluble active ingredient.

34. An oral administration form according to claim 1, wherein said active ingredient is selected from the group consisting of plant extracts and homeopathic medicines.

35. A method according to claim 16, wherein said active ingredient is selected from the group consisting of plant extracts and homeopathic medicines.
